(19) United States
(12) Patent Application Publication
(10) Pub. No.: US 2004/0037085 A1
(43) Pub. Date: Feb. 26, 2004

(54) Photoswitch-controlled wheel light

(76) Inventor: Gioacchino A. Panzarella, Garfield, NJ (US)

Correspondence Address: LOWENSTEIN SANDLER PC, 65 LIVINGSTON AVENUE, ROSELAND, NJ, 07068, US

(21) Appl. No.: 10/224,944

(22) Filed: Aug. 21, 2002

(51) Int. Cl. B60Q 1/26

(52) U.S. Cl. 362/500; 362/1; 362/802; 362/208

(57) ABSTRACT

A photoswitch-controlled wheel light for a vehicle wheel having an air-valve stem. A housing is adapted to connect the light to the wheel's air-valve stem. A power source is positioned within a housing to power a light source. A photoswitch activates the light source when it is placed in a darkened environment. Thus the wheel light of the invention provides a visually stimulating image as the wheel to which it is attached rotates in a darkened environment, for example, nighttime driving.

### 1. FIELD

The present invention relates to the field of accessory lights for vehicles and, more particularly, to a photoswitch-controlled wheel light for vehicle wheels.

### 2. BACKGROUND

Accessory lights of various kinds have become popular for enhancing the appearance of a vehicle. Some accessory lights are purely functional, for example, to provide improved visibility in low-light conditions, enhancing safety. Colored lights for decoratively lighting various portions of a motor vehicle have also become popular, including accessory lights connected to vehicle wheels. The most common wheel-lighting devices are reflectors, which do not emit light. Wheel lights that that emit light can provide a more stimulating visual effect, but are often inconvenient because they must be manually switched on and off. Such manually controlled lights can be adapted for attachment to the vehicle's air-valve stem by a mechanical connector but are activated on contact with the valve stem and remain activated for as long as the battery lasts.

U.S. patent Publication Ser. No. 2002/0089858 (published Jul. 11, 2002) describes a wheel light having a motion sensitive switch that turns on the light when the wheel is in motion, and deactivates the light when the wheel to which it is attached is not in motion. Unfortunately, however, such a wheel light will still needlessly be on and wasting power when operated during the daytime.

Thus, there is need for a wheel light that conserves battery life by preventing the light from being activated under lighted conditions, such as daytime.

### 3. SUMMARY

The present invention advantageously provides a photoswitch-controlled wheel light for a vehicle wheel having an air-valve stem. The wheel light comprises a mechanical connector for connecting the light to the air-valve stem; a power source; a photoswitch; and a light source connected to the power source through an electrical circuit comprising a photoswitch. The photoswitch activates the light under predetermined lighting conditions in accordance with the preselected light sensitivity of the photoswitch. Photoswitches of varying sensitivity may be employed so as to activate the wheel light under conditions such as cloudy or dusk conditions, or total darkness, so the light does not function needlessly under bright lighting conditions, thereby conserving battery life.

Optionally the wheel light of the invention can further comprise a motion-activated switch connected to the power source and to the light source, so as to activate the light source only upon a combination of darkened lighting conditions and motion of the wheel. In this embodiment, the switch is responsive to a centrifugal force generated when the vehicle wheel rotates such that the circuit path through the motion-activated switch is closed when the wheel is turning. The light source is activated when the motion-activated switch and the photoswitch, wired in series, are both closed so as to complete a circuit, thereby lighting the vehicle wheel.

The wheel light can be housed in an enclosure for protecting the wheel light's components and, preferably, also serves to connect the wheel light to the wheel.

The wheel light may comprise a shape for forming a visually perceptible light image when the motion of the vehicle wheel in combination with darkened lighting conditions activates the light source.

Thus, in one embodiment, the invention comprises a wheel light comprising:

(a) a mechanical connector complementary to an air-valve stem for connecting the wheel light thereto;

(b) a power source;

(c) a light source;

(d) a photoswitch; and

(e) an electrical circuit connecting the power source, light source and photoswitch.

In another embodiment, the invention comprises a method of lighting a wheel having an air-valve stem comprising:

(a) connecting a wheel light to the wheel, the wheel light comprising:

(i) a mechanical connector complementary to the air-valve stem for connecting the wheel light thereto;

(ii) a power source connected in an electrical circuit, the electrical circuit comprising a photoswitch; and

(iii) a light source connected to the power source through the electrical circuit; and

(b) locating the wheel in a darkened environment to activate the light source.

### 4. BRIEF DESCRIPTION OF THE FIGURES

These and other features, aspects, and advantages of the present invention will become better understood with regard to the following description, appended claims, and accompanying drawings where:

FIG. 1 is a drawing of a wheel light of the invention connected to the valve stem of a wheel;

FIGS. 2A-2C are perspective views of embodiments of the wheel light of the invention;

FIGS. 3A and 3B are schematic diagrams of a circuit for use in the invention;

FIG. 4 is a schematic diagram of a photoswitch for use in the invention;

FIG. 5 is a schematic diagram of a motion-activated switch for use in the invention; and

FIG. 6 illustrates a circuit diagram of another embodiment of the invention wherein the wheel light activates only in a dark environment when the wheel to which it is attached is moving.

### 5. DETAILED DESCRIPTION

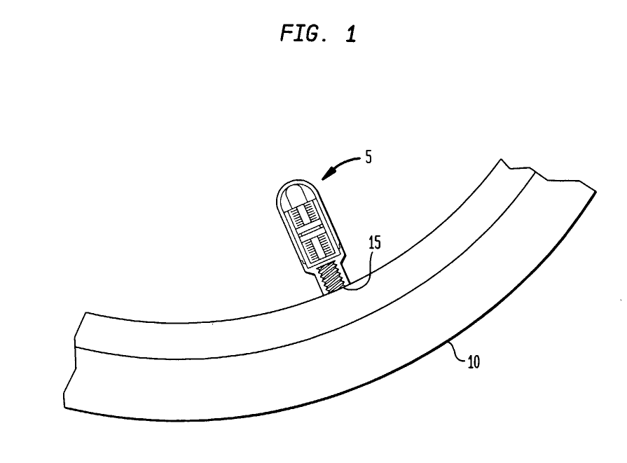

The present invention will now be described more fully with reference to FIGS. 1 through 6, which illustrate a few embodiments of the invention. But the invention and claims thereof should not be construed as limited by or to the preferred or specific embodiments described by the Summary § 3, Drawings § 4, or Detailed Description § 5. These embodiments are provided merely to disclose the best mode and to enable one of skill in the art to practice the full scope of the invention. Like numbers refer to like elements throughout, and prime notation, when used, indicates similar elements.

As shown in FIG. 1, photoswitch controlled wheel light of the invention 5 connects to vehicle wheel 10 having air-valve stem 15 to create a visually stimulating image as wheel 10 rotates when activated by a darkened environment. It is well known in the art that vehicle wheels 10, particularly those of modern vehicles having tubeless pneumatic tires, comprise air valves wherein the valve stem 15 is connected directly to the wheel rim. Alternatively, in a vehicle whose tires include an inner tube, for example, in many bicycles, the air-valve stem 15 is part of the inner tube and protrudes from the wheel rim by fitting through an opening therein. The wheel light of the invention is intended to connect to any such type of air-valve stem, whether the pneumatic tire includes an inner tube or not.

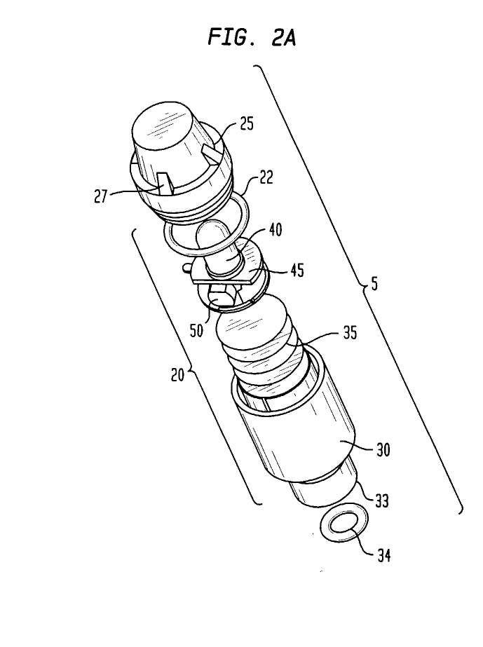

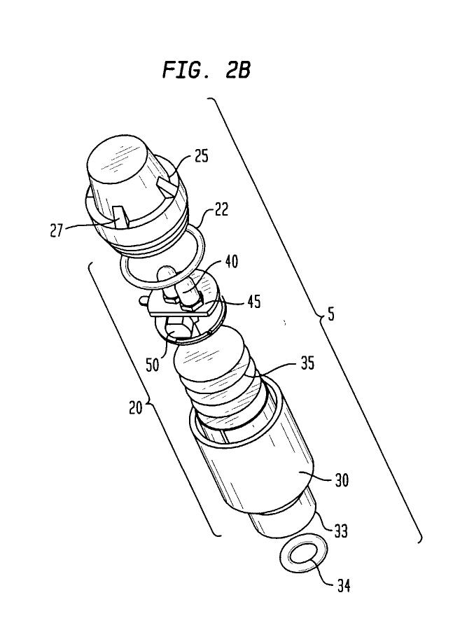

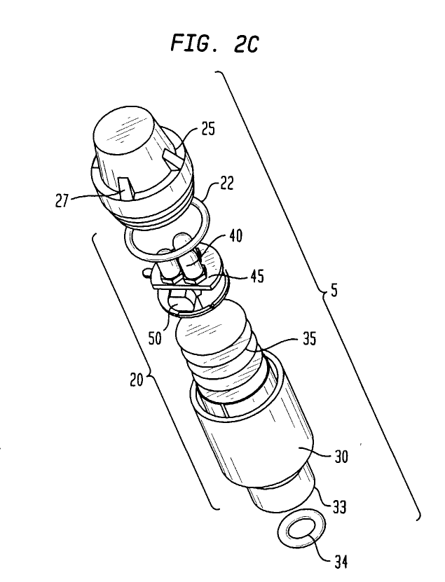

FIGS. 2A-2C illustrate embodiments of a wheel light of the invention having one (FIG. 2A), two (FIG. 2B), and three (FIG. 2C) light sources (e.g., one, two, or three light emitting diodes). As shown in FIGS. 2A-2C, wheel light 5 comprises housing 20, which, in turn, comprises upper cabinet 25 and lower cabinet 30. Rubber rings 22 can be used between upper cabinet 25 and lower cabinet 30 for a weatherproof seal. Preferably, housing 20 provides a weatherproof environment for power source 35, light source 40, and circuit assembly 45. Circuit assembly 45 comprises photoswitch 50. Power source 35 can be any electrical source, including the attached vehicle's main battery (of course with the proper electrical connection). Preferably, power source 35 comprises one or more batteries, preferably, three to six batteries of about 1.5 volts each. Preferably, light source 40 is one or more light emitting diodes, however, those of skill in the art will readily appreciate that 40 can be any suitable light emitter, such as an incandescent light bulb or halogen light bulb. Upper cabinet 25 of housing 20 preferably comprises a translucent or transparent material so as to allow emitted light to shine through and can be clear or colored to emit colored light. Upper cabinet 25, preferably, is fabricated from plastic material to provide a substantially weatherproof enclosure. Optionally, upper cabinet 25 can comprise striations 27 to help scatter light emitted by the light source 40.

Lower cabinet 30 of housing 20 additionally comprises mechanical connector 33 adapted to connect wheel light 5 to air-valve stem 15 of a vehicle wheel 10 (see FIG. 1). Such mechanical connectors 33 are well known in the art. For example, suitable mechanical connectors include, but are not limited to, threads, such as female threads complimentary to the male threads typically found on a wheel air-valve stems; pressure couplings; or by any other connecting methods well known to those skilled in the art.

As shown in FIGS. 2B and 2C, wheel light 5 is adaptable to function with one or multiple light sources 40, for example, multiple light-emitting diodes. When multiple light-emitting diodes are used in wheel light 5 they may each emit a different color of light, thereby creating a stimulating visual effect. For example, light source 40 can comprise three light emitting diodes, wherein one emits red light, one green light, and one blue light.

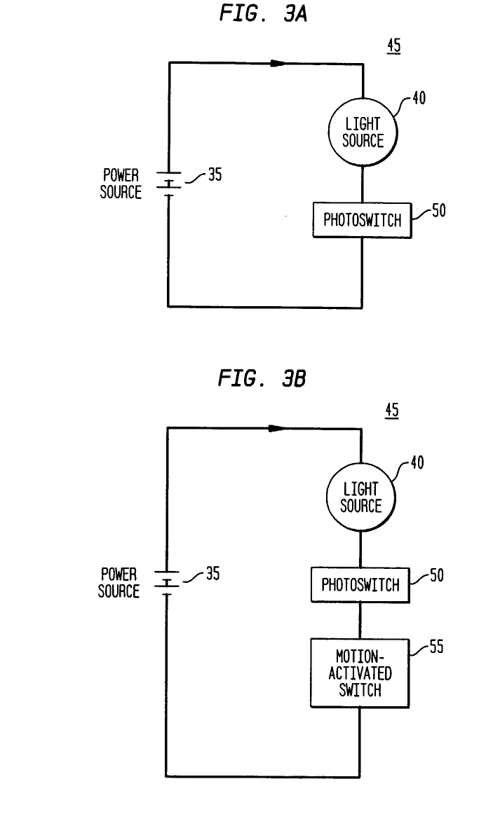

A schematic diagram of circuit assembly 45, further including power source 35, is provided in FIG. 3A. Power source 35 is electrically connected to light source 40 and photoswitch 50 as shown. FIG. 3B illustrates another embodiment of the invention wherein the circuit assembly 45 further comprises motion-activated switch 55.

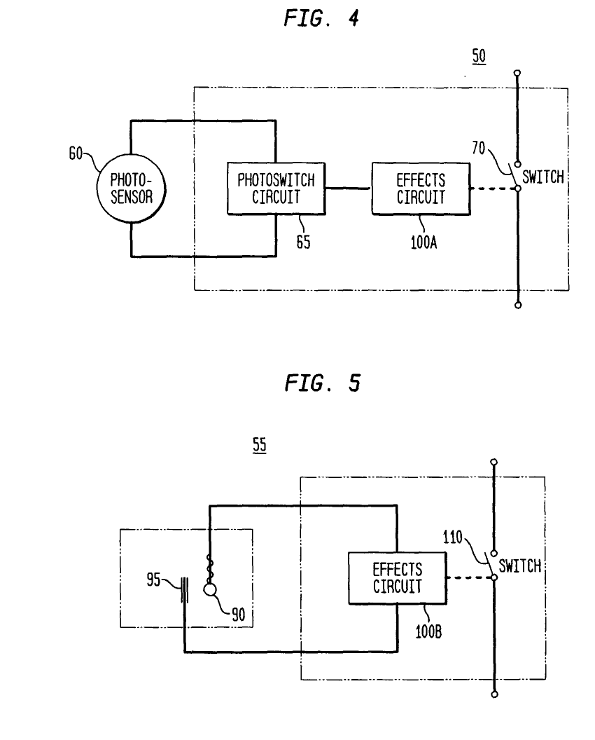

As illustrated in FIG. 4, a basic photoswitch 50 comprises a photosensor 60 to detect light intensity. When the light intensity falls below a predetermined level, as measured by photosensor 60, photoswitch circuit 65 activates switch 70 and the wheel light of the invention is activated. Effects circuit 100A can provide a variety of visual, timing, and other effects to improve the wheel light's performance. Preferably, photoswitch 50 has a high degree of repeatability, so that switch 70 is activated as a function of light intensity (and not of time, temperature, or other incidental variables).

Photosensor 60 can be any conventional sensor capable of controlling switch 70 to turn off light source 40 when ambient lighting intensity meets or exceeds a predetermined level (such as, for example, the transition from night-time to day-time) and turn on light source 40 when ambient lighting intensity falls below a predetermined level (such as, for example, the transition from day-time to night-time). Examples of such sensors include, but are not limited to, cadmium sulfide cells, photovoltaic cells, photodiodes, and phototransistors. Photoswitches 50 are well known in the art and used in a variety of commercial applications, such as automatic street lamps, automatic nightlights, and many others. Suitable photoswitches for use in the invention are disclosed in U.S. Pat. No. 5,760,558 (issued Jun. 2, 1998), hereby incorporated herein by reference.

Effects circuit 100A can be configured to control the lighting-interval rate, lighting sequence, and other parameters associated with light source 40. For example, effects circuit 100A of photoswitch 50 can be configured with a broad range of time-constants, preferably, a time-constant of from about several seconds to about several minutes. Such a time constant reduces error frequency due to short-term illumination events, such as street lamps, on-coming headlights, and variations in lighting intensity striking the photosensor due to rotational movement of the wheel to which it is attached.

In another embodiment, effects circuit 100A can intermittently activate the light source 40 to create interesting visual effects. For example, wheel lights 5 having different predetermined activating intervals could be connected to the four wheels of a car, so that each wheel 10 flashes at asynchronous times relative to the other wheels.

In still another embodiment, effects circuit 100A can be configured to sequence the activation of multiple light sources 40. For example, effects circuit 100A can be configured to activate multiple light sources 40 of different colors (or single light sources that can emit multiple colors, such as bi- or tri-color light emitting diodes) in a predetermined sequence so that different colored light sources are activated at random times, or in any number of possible predetermined patterns, depending on the number of light sources. Thus, a rotating wheel 10 could be made to flash different colors in a predetermined or random sequence.

Optionally, as shown in FIG. 3B, circuit assembly 45 can further comprise motion-activated switch 55 that, in series with the photoswitch, completes a circuit between power source 35 and light source 40 upon sufficient movement. Preferably, motion-activated switch 55 is sensitive to rotational motion for example, rotation of wheel 10. In this embodiment, the wheel light of the invention will activate only when both the light intensity is at the predetermined intensity (photoswitch 50) and when the wheel is moving (motion-activated switch 55).

FIG. 5 illustrates the components of a basic motion-activated switch 55 for use in the invention. Motion-activated switch 55 comprises a switch contact 90 suspended adjacent a contact plate 95. Movement of the wheel light 5 causes the switch contact 90 to vibrate sufficiently to touch the contact plate 95 thereby activating switch 110 and closing the electrical circuit to activate light source 40. When movement of wheel light 5 ceases, vibration of the switch contact 90 is reduced and eventually stops, the switch contact moves away from the contact plate 95, and switch 110 is opened, turning off the light source 40. In this embodiment, the switch contact 90 is preferably a spring coil formed from a wire. The vibrational characteristics of switch contact 90 depend on factors known in the art, such as the gauge of wire used to make the spring coil, the number of coils in the spring, the tensile strength of the wire and, therefore, its resistance to bending. Careful control of such characteristics provides a switch contact 90 having a predetermined sensitivity to motion.

Similar to effects circuit 100A used in photoswitch 50, effects circuit 100B can be configured to control the rate, sequence, and other characteristics for activating the light source 40. For example, the effects circuit 100B can minimize light source activation due to random movement (as opposed to rotational motion) such as experienced during shipment of wheel light 5; to activate the light source for a predetermined time following movement of the wheel; or to intermittently close the electrical circuit upon movement to emit flashes of light.

Motion-activated switches for use in the invention are well known in the art. Suitable motion-motion activated switches for use in the invention are disclosed in U.S. patent Publication Ser. No. 2002/0089858 (published Jul. 11, 2002), paragraphs 0023-0026, hereby incorporated herein by reference.

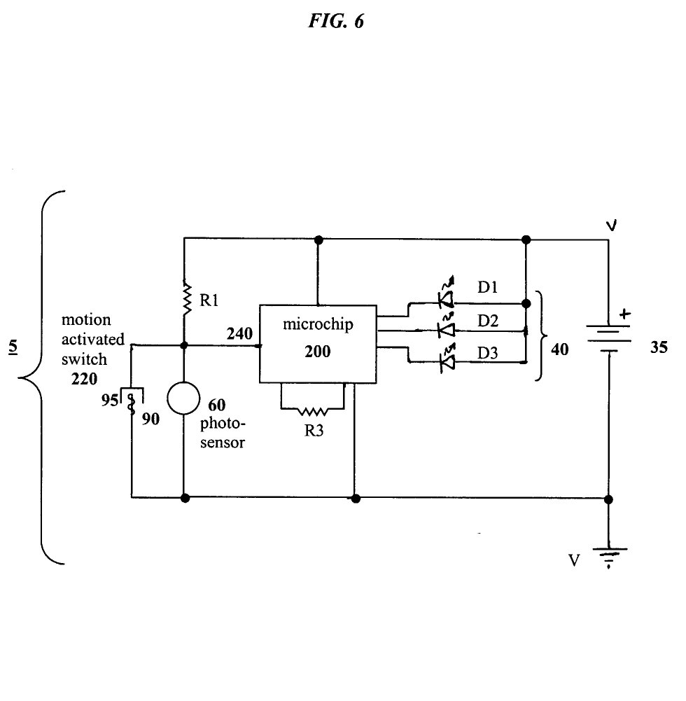

FIG. 6 is a circuit diagram of another embodiment of the invention wherein wheel light 5 activates only in a dark environment when the wheel to which it is attached is moving. That is, the wheel activates only when the photosensor senses a light intensity below a predetermined level and the motion-activated switch senses motion. As shown in FIG. 6, wheel light 5 comprises microchip 200; motion-activated switch 220 (which comprises switch contact 90 and contact plate 95); resistor R1; photosensor 60; light source 40 (comprising three light emitting diodes D1, D2, and D3); power source 35; and microchip configuration resistor R3. Motion activated switch 220 and photocell 60 are connected directly to one of microchip 200's inputs 240. Microchip input 240 is sensitive to a change in voltage. When photocell 60 is illuminated, the voltage at microchip input 240 will remain low without a voltage change. In darkness photocell 60 exhibits a relatively high resistance and the input voltage to the microchip 200 is determined solely by the open or closed state of motion-activated switch 220. When the wheel is in motion motion-activated switch 220 closes and the voltage at microchip input 240 is pulled low. When the microchip detects the high to low voltage transition at input 240 microchip 200 causes lights D1, D2, and D3 activate, for example to flash for a predetermined number of cycles, such as 32 cycles.

Another embodiment of the invention relates to an image formed by a wheel light of the invention. Light source 40 itself can be in the shape of a particular image or design. To enhance the effect, the wheel light 5 may be configured to emit light of one or more colors. The light source 40 itself may emit colored light, or the upper cabinet 25 may comprise material having one or more colors to thereby produce a visually perceptible image in color as the wheel 10 rotates.

Although the present invention has been described in considerable detail with reference to certain preferred embodiments and versions, other versions and embodiments are possible. Therefore, the scope of the appended claims should not be limited to the description of the versions and embodiments expressly disclosed herein.

What is claimed is:

1. A wheel light comprising:
(a) a mechanical connector complementary to an air-valve stem for connecting the wheel light thereto;
(b) a power source;
(c) a light source;
(d) a photoswitch; and
(e) an electrical circuit connecting the power source, light source and photoswitch.

2. The wheel light of claim 1, wherein the photoswitch comprises a time-constant of one or more seconds.

3. The wheel light of claim 1, wherein the mechanical connector comprises threads complementary to the air-valve stem for connecting the wheel light to the air-valve stem.

4. The wheel light of claim 1, wherein the mechanical connector comprises a pressure coupling for connecting the wheel light to the air-valve stem.

5. The wheel light of claim 1, further comprising a housing.

6. The wheel light of claim 5, wherein the housing provides a substantially weatherproof enclosure for the wheel light.

7. The wheel light of claim 5, wherein the housing comprises the mechanical connector.

8. The wheel light of claim 1, wherein the power source comprises a battery.

9. The wheel light of claim 1, wherein the light source comprises a light emitting diode.

10. The wheel light of claim 9, wherein the light emitting diode can emit two or more colors of light.

11. The wheel light of claim 1, wherein the light source comprises two or more light emitting diodes.

12. The wheel light of claim 1, wherein the light source comprises two or more light emitting diodes that emit two or more different colors.

13. The wheel light of claim 1, further comprising a pneumatic tire, the pneumatic tire comprising the air-valve stem, wherein the wheel light is connected to the air-valve stem by way of the mechanical connector.

14. The wheel light of claim 1, further comprising an effects circuit.

15. The wheel light of claim 14, further comprising two or more light emitting diodes, wherein the effects circuit activates the two or more light emitting diodes in a predetermined pattern.

16. The wheel light of claim 15, wherein the predetermined pattern includes a pattern selected from the group consisting of flashing, random, and sequential.

17. The wheel light of claim 1, further comprising a motion-activated switch connected to the electrical circuit to activate the light source in response to movement.

18. The wheel light of claim 17, wherein the motion-activated switch intermittently closes the electrical circuit upon movement to thereby cause the light source to emit flashes of light.

19. The wheel light of claim 17, wherein the motion-activated switch activates the light source for a predetermined time following movement of the wheel.

20. The wheel light of claim 17, wherein the light source activates only when the photoswitch and the motion-activated switch are both closed.

21. The wheel light of claim 17, wherein the light source activates only when the photosensor senses a light intensity below a predetermined level and the motion activated switch senses motion.

22. A method of lighting a wheel having an air-valve stem, the method comprising:
(a) connecting a wheel light to the wheel, the wheel light comprising:
(i) a mechanical connector complementary to the air-valve stem for connecting the wheel light thereto;
(ii) a power source connected in an electrical circuit, the electrical circuit comprising a photoswitch; and
(iii) a light source connected to the power source through the electrical circuit; and
(b) locating the wheel in a darkened environment to activate the light source.

23. The method of claim 22, wherein connecting the wheel light to the air-valve stem comprises screwing the wheel light onto the air-valve stem by way of threads on the mechanical connector that are complementary to threads on the air-valve stem.

24. The method of claim 22, wherein the light source comprises a light emitting diode.

25. The method light of claim 22, wherein the light source comprises multiple light emitting diodes.

26. The method of claim 22, wherein the light source comprises two or more light emitting diodes that emit two or more different colors.

27. The method of claim 22, wherein the wheel light further comprises a motion-activated switch connected in the electrical circuit so as to activate the light source upon movement, the method further comprising moving the wheel sufficiently to activate the light source.

28. The method of claim 27, wherein moving the wheel comprises driving a vehicle having the wheel attached thereto.
